(19) United States
(12) Patent Application Publication
(10) Pub. No.: US 2010/0171758 A1
(43) Pub. Date: Jul. 8, 2010

(54) Method and system for generating augmented reality signals

(75) Inventors: Paul W. Maassel, Saint Leonard, MD (US); Justin Thomas, Saint Leonard, MD (US)

Correspondence Address: Finnegan, Henderson, Farabow,;Garrett & Dunner, L.L.P., 901 New York Avenue, NW, Washington, DC, 20001-4413, US

(73) Assignee: Reallaer LLC

(21) Appl. No.: 12/659,567

(22) Filed: Mar. 12, 2010

Related U.S. Application Data
(62) Division of application No. 11/640,185, filed on Dec. 18, 2006.

(51) Int. Cl. H04N 5/265; G09G 5/00

(52) U.S. Cl. 345/632; 348/598; 348/E05.056

(57) ABSTRACT

Embodiments consistent with the present disclosure provide method and systems for providing customized augmented reality data comprising. The method includes Some embodiments consistent with the present disclosure provide a method for providing customized augmented reality data. The method includes receiving geo-registered sensor data including data captured by a sensor and metadata describing a position of the sensor at the time the data was captured and receiving geospatial overlay data including computer-generated objects having a predefined geospatial position. The method also includes receiving a selection designating at least one portion of the geo-registered sensor data, said at least one portion of the geo-registered sensor data including some or all of the geo-registered sensor data, and receiving a selection designating at least one portion of the geospatial overlay data, said at least one portion of the geospatial overlay data including some or all of the geospatial overlay data. And the method includes providing a combination of the at least one selected portion of the geo-registered sensor data and the at least one selected portion of geospatial overlay data, said combination being operable to display the at least one selected portion of the geo-registered sensor data overlaid with the at least one selected portion of geospatial overlay data based on the position of the sensor without receiving other geo-registered sensor data or other geospatial overlay data.

### TECHNICAL FIELD

Systems and methods consistent with the present invention relate to augmented reality. More particularly, the invention relates to systems and methods for automatically generating augmented reality images.

### BACKGROUND

Modern information systems enable individuals to interact with large quantities of information. However, as the amount of information grows, it becomes increasingly necessary to combine the information and present it in a manner suited to a user's particular needs.

One technique for presenting combinations of information is “augmented reality.” Generally, augmented reality systems present real-world and virtual reality data in a combined display. In one aspect, augmented reality systems enhance real-world images with computer-generated elements that help users identify or interpret the real-world information. For example, a computer may generate a digital image of a town including labels identifying specific streets and buildings within the image. In another aspect, augmented reality systems allow otherwise hidden information to be visualized in the context of the real-world. A simple example would be displaying a virtual reality representation of underground electrical conduits overlaid on real-world images of a city street.

Augmented reality systems also may be adapted to support military command, control, navigation, surveillance and reconnaissance systems, as well as other applications, such as emergency response, law enforcement, and homeland defense. For instance, a vehicle equipped with an augmented reality unit may generate displays that assist an operator in a mission requiring the operator to navigate the vehicle to a specific destination. To enhance the operator's situational awareness as the vehicle travels to the destination, the augmented reality system may display real-time video overlaid with information displayed as computer-generated graphics geo-spatially referenced to the video. The information may be stored in the augmented reality system before the mission or the information may be downlinked in real-time during the mission from data-gathering systems, such as satellites, aircraft, and other vehicles. Simultaneously, the augmented reality system may also record the geo-registered images by capturing video from a digital camera system and position and orientation data from a geospatial positioning system.

After the mission, the recorded geo-registered image data may be shared by various post-mission analysts for purposes such as, mission evaluation, training, coordination, intelligence-gathering, and damage assessment. Although each user may use essentially the same set of recorded data, one user may require that the data be presented from an alternate perspective or include additional data not required by another user. For instance, a first mission analyst may require the data recorded from a single operator's vehicle to perform a tactical review. In comparison, a second mission analyst may require a combination of data acquired from a variety of sources and operators at different times to perform a strategic analysis.

Some augmented reality systems, however, store data in formats that limit users' ability to customize augmented reality data for provision to subsequent users. For instance, a user who receives recorded mission data may not be able to further add, edit, or replace the recorded mission data and virtual reality data. Consequently, the user has limited ability to combine the data in a presentation that is most relevant to the user's role or requirements. In addition, a subsequent user may receive recorded mission data but lack other information necessary to playback the mission data. For instance, a subsequent user who receives the mission data may lack a geospatial overlay data required to playback or analyze the mission data. In other cases, the provided mission data may include portions that have become outdated and/or irrelevant. A subsequent user may possess new data for that portion; but, because the portions of the mission data cannot be independently modified or replaced, the user is forced to rely on the obsolete data.

The disclosed systems and methods are directed to approaches that may overcome or at least partially obviate one or more of the problems and/or drawbacks discussed above.

### SUMMARY

Some embodiments consistent with the present disclosure provide a method for providing customized augmented reality data. The method includes receiving geo-registered sensor data including data captured by a sensor and metadata describing a position of the sensor at the time the data was captured and receiving geospatial overlay data including computer-generated objects having a predefined geospatial position. The method also includes receiving a selection designating at least one portion of the geo-registered sensor data, said at least one portion of the geo-registered sensor data including some or all of the geo-registered sensor data, and receiving a selection designating at least one portion of the geospatial overlay data, said at least one portion of the geospatial overlay data including some or all of the geospatial overlay data. And the method includes providing a combination of the at least one selected portion of the geo-registered sensor data and the at least one selected portion of geospatial overlay data, said combination being operable to display the at least one selected portion of the geo-registered sensor data overlaid with the at least one selected portion of geospatial overlay data based on the position of the sensor without receiving other geo-registered sensor data or other geospatial overlay data.

Some embodiments consistent with the present disclosure provide a system for providing customized augmented reality data. The system includes a computer having a microprocessor and a computer-readable medium coupled to the microprocessor, and a program stored in the computer-readable medium. When executed by the microprocessor, the program is operable to receive geo-registered sensor data including data captured by a sensor and metadata describing a position of the sensor at the time the data was captured, and receive geospatial overlay data including computer-generated objects having a predefined geospatial position. The program is also operable to receive a selection designating at least one portion of the geo-registered sensor data, said at least one portion of the geo-registered sensor data including some or all of the geo-registered sensor data, and receive a selection designating at least one portion of the geospatial overlay data, said at least one portion of the geospatial overlay data including some or all of the geospatial overlay data. And the program is operable to provide a combination of the at least one selected portion of the geo-registered sensor data and the at least one selected portion of geospatial overlay data, said combination being operable to display the at least one selected portion of the geo-registered sensor data overlaid with the at least one selected portion of geospatial overlay data based on the position of the sensor without receiving other geo-registered sensor data or other geospatial overlay data.

Some embodiments consistent with the present disclosure provide a method for providing customized augmented reality data. The method includes receiving geo-registered sensor data including data captured by a sensor and metadata describing a position of the sensor at the time the data was captured, and storing the geo-registered sensor data in a frame database that references frames of geo-registered sensor data based on at least one of a position at which the frame was recorded, a time the frame was recorded, and a source of the frame. The method also includes receiving geospatial overlay data including computer-generated objects having a predefined geospatial position, and storing the geospatial overlay data in an overlay database that references computer-generated objects based on at least one of a geospatial position of each object. The method also includes receiving a selection designating at least one portion of the geo-registered sensor data in the sensor frame database, said at least one portion of the geo-registered sensor data including some or all of the sensor frame database, and receiving a selection designating at least one portion of the geospatial overlay data in the overlay database, said at least one portion of the geospatial overlay data including some or all of the geospatial overlay data in the overlay database. And the method includes encoding a mission data file including the at least one selected geo-registered sensor data and the at least one selected geospatial overlay data, said mission data file being operable to display the selected portions of the geo-registered sensor data overlaid with the geospatial overlay data based on the position of the sensor without receiving other geo-registered sensor data or other geospatial overlay data.

It is to be understood that both the foregoing general description and the following detailed description are exemplary and explanatory only and are not restrictive of the invention.

### BRIEF DESCRIPTION OF THE DRAWINGS

The accompanying drawings, which are incorporated in and constitute a part of this specification, illustrate several exemplary embodiments consistent with aspects of the present invention and together with the description, serve to explain some of the principles of the invention. In the drawings:

FIG. 1 is a overview of an exemplary environment consistent with the disclosed embodiments;

FIG. 2 is a block diagram illustrating an exemplary system consistent with the disclosed embodiments;

FIG. 3 is a functional block diagram illustrating an exemplary system, consistent with the disclosed embodiments;

FIG. 4 is block diagram illustrating exemplary data, consistent with the disclosed embodiments; and

FIG. 5 is a flowchart, illustrating an exemplary method, consistent with the disclosed embodiments.

### DETAILED DESCRIPTION

The following detailed description refers to the accompanying drawings. Where appropriate, the same reference numbers in different drawings refer to the same or similar elements.

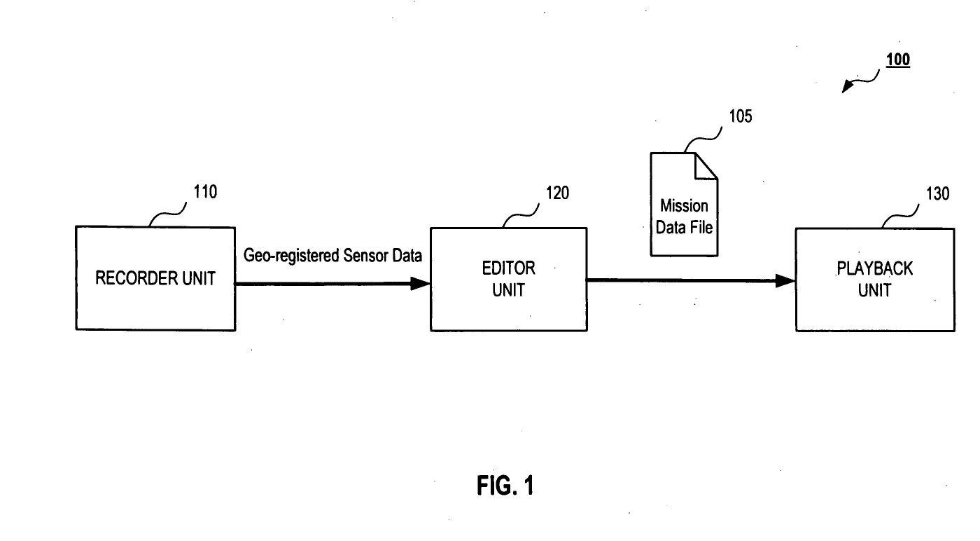

FIG. 1 provides a block diagram exemplifying a system environment 100 consistent with embodiments of the present invention. Exemplary system environment 100 may include mission data file 105, a recorder unit 110, an editor unit 120, and a playback unit 130. Together, units 110-130 enable recording, modifying, and displaying of mission data file 105 from geo-registered sensor data and other sources.

A mission data file 105 is a stand-alone module of augmented reality data including, at least, geo-registered sensor data and geospatial overlay data that, when executed by a processor, may be operable to provide an augmented reality presentation. Geo-registered sensor data may include data captured from a sensor along with metadata describing, for example, the position of the sensor, as well as the time the data was captured by the sensor. Position data may include information, such as the sensor's latitude, longitude, altitude, and orientation (i.e., point of view). For example, geo-registered sensor data may be frames of audiovisual data captured by a camera and tagged with position and time data provided by an associated global positioning unit.

Geospatial overlay data, in comparison, may be computer-generated objects having a predefined geospatial position data describing the location and/or geometry of the objects. Objects may include information including alphanumeric texts, icons, pictures, symbols, shapes, lines, and/or three-dimensional geometries. Objects may also include two-dimensional and three-dimensional virtual objects, such as buildings, vehicles, streets, foliage, and clouds. Using the position data associated with the geospatial overlay data and the geo-registered sensor data, the geo-registered sensor data may be augmented by overlaying objects included in the geospatial overlay data.

Mission data file 105 may include many separate data files combined into a single data module. By decoding data from mission data file 105, recorder unit 110, editor unit 120, and/or playback unit 130 may render a complete augmented reality presentation using the geo-registered sensor data or geospatial overlay data included in mission data file 105. In some instances, mission data file 105 may be encoded (e.g., compressed) in a portable document format that may be decoded and rendered using any playback unit 130 configured to receive, decode, and render the mission data file, and without referencing geo-registered sensor data or geospatial overlay data other than that which is included mission data file 105.

Recorder unit 110 may be a portable data processing system that executes instructions for decoding a mission data file, displaying augmented mission data, and capturing geo-registered sensor data. Recorder unit 110 may include devices such as a display, a positioning unit, a video recorder, an audio recorder, and a user input. For instance, the recorder unit 110 may be a vehicle-mounted device, such as a communications, display, and navigation unit, or an automobile satellite-navigation system. In other instances, the recorder unit 110 may be a man-portable unit, such as a laptop computer, personal digital assistant, digital camera, or other device combined with a positioning unit.

Editor unit 120 may be a data processing system that executes instructions for generating augmented reality presentations and encoding mission data files 105. Editor unit 120 may receive geo-registered sensor data from, for example, recorder unit 110. Although, not shown in FIG. 1, editor unit 120 may alternatively or additionally receive geo-registered sensor data and geospatial overlay data from other sources, such as an existing mission data file, simulation databases, satellite imagery, aerial photography, and/or digitized maps. Using editor unit 120, a user may add, remove, and/or update data included in a mission data file 105 or for rendering in a presentation with playback unit 130. For instance, the user may select various layers of data for presentation and define scripts for playing back the data in a predefined manner. Once the user completes his modifications, editor unit 120 may encode an updated mission data file 105 from the geo-registered sensor data and geospatial overlay data stored in the editor unit 120. The new mission data file 105 may be provided for use in the recorder unit 110 or playback unit 130.

Playback unit 130 may be a data processing system including instructions for receiving a mission data file 105, extracting, at least, geo-registered sensor data from the file, and displaying an augmented reality presentation to a user. An augmented reality presentation may be an audiovisual presentation including real-time video, a sequence of still images, and associated sounds selectively augmented with audio. The playback unit 130 may enable a user to navigate mission data using VCR-like controls provided by a user interface. Via the user interface, a user may, for example, play, pause, cue, review, and stop the presentation of mission data. In addition, the user interface may enable a user to selectively toggle on and off the layers of geo-registered sensor data and/or geospatial overlay data to include in the mission data presentation. Furthermore, through the playback unit 130, a user may view predefined scripts. In addition, a user may select marker data serving as bookmarks, allowing a user to jump to particular locations or points of time recorded in geo-registered sensor data and/or included within a presentation.

In some embodiments, the playback unit 130 may be combined within a single device also including the features of the above-described recorder unit 110 and/or editor unit 120. However, in other embodiments of the present invention, playback unit 130 functions may be limited to playback of mission data and toggling of select layers already included within the mission data. Furthermore, even though FIG. 1 illustrates recorder unit 110, editor unit 120, and playback unit 130 as separate devices, some or all of all of the above-described functionality of each unit may be combined into a single device. For example, the recorder unit 110, editor unit 120, and playback unit 130 may be combined within a single device.

By way of example, as illustrated in FIG. 1, recorder unit 110 may receive mission data file 105 prepared using editor unit 120 and customized to include geo-registered sensor data and geospatial overlay data relevant to a particular mission. For instance, a participant in a search and rescue mission may be provided with data corresponding to a geographic region where the mission will be performed. When a user prepares for the mission, the user may select geospatial overlay data for inclusion in the mission data file 105, along with data from other sources, such as mission planning software and intelligence tools, to create supplemental geospatial overlay data for augmenting audiovisual sensor data, map data, and other geo-referenced audiovisual data while performing a mission.

During the mission, recorder unit 110 may display an augmented reality presentation generated from geo-registered sensor data. For example, an operator may selectively view data presented in a variety of formats, including real-time “out the window” video captured by a video recorder; a bird's-eye-view rendered from a geospatial overlay database; a “god's-eye-view” captured from a satellite; or a map view. Each different view may be augmented with computer-generated objects rendered from the geospatial overlay data. The out-the-window view may be, for instance, augmented by the recorder unit to include three-dimensional arrows directing the operator to a destination, along with names of streets and other locations. Furthermore, the augmented reality presentation may include other geospatial objects such as simulated vehicles, roadblocks, color coding, etc. Similar information may be rendered in a two-dimensional view if a user switches, for example, to a god's-eye-view.

While a mission is in progress, recorder unit 110 may record geo-registered sensor data, including audiovisual data. Geo-registered sensor data also may be received from external sources (e.g., reconnaissance and surveillance platforms) and/or other sensors (e.g., ultra violet, infra-red, radar, etc.). In addition, recorder unit 110 may record event marker data that provide geo-referenced indicators of events, objects, and/or conditions. In some cases, event markers may be input by a user. For instance, through a user input device, a user may draw a virtual circle around an object displayed by the recorder unit 110 to identify the object as suspicious. Or, in other examples, a user may draw an “x” over a building to indicate that the building had been searched or destroyed. The recorder unit 110 may also automatically record marker data. For example, the recorder unit 110 may record virtual “breadcrumbs” at regular time and/or distance intervals to record the path traveled by a vehicle. Alternatively, the recorder unit 110 may record marker data when at predefined coordinates or points in time.

During or subsequent to the mission, the captured geo-registered sensor data and/or mission data file 105 may be provided to editor unit 120. Editor unit 120 may extract the received data and possibly also combine the captured geo-registered sensor data with any sensor data already present in the original mission data file or additional data from another source. Likewise, editor unit 120 may extract the geospatial overlay data and, if required, combine it with data from other geospatial sources (e.g., satellite imagery). Through editor unit 120, a user may selectively modify and combine the data to fit that user's requirements. Based on the received data, editor unit 120 may encode an updated mission data file which may be provided to playback unit 130 for rendering and/or recorder unit 110 to support a subsequent mission.

Although FIG. 1 only illustrates one each of a recorder unit 110, editor unit 120 and playback unit 130, environment 100 may include any number of these units. For instance, each of several editor units 120 may receive data from a plurality of recorder units 110. In addition, each editor unit 120 may provide mission data file 105 to many different recorder units 110 and/or playback units 130 used by a plurality of different users.

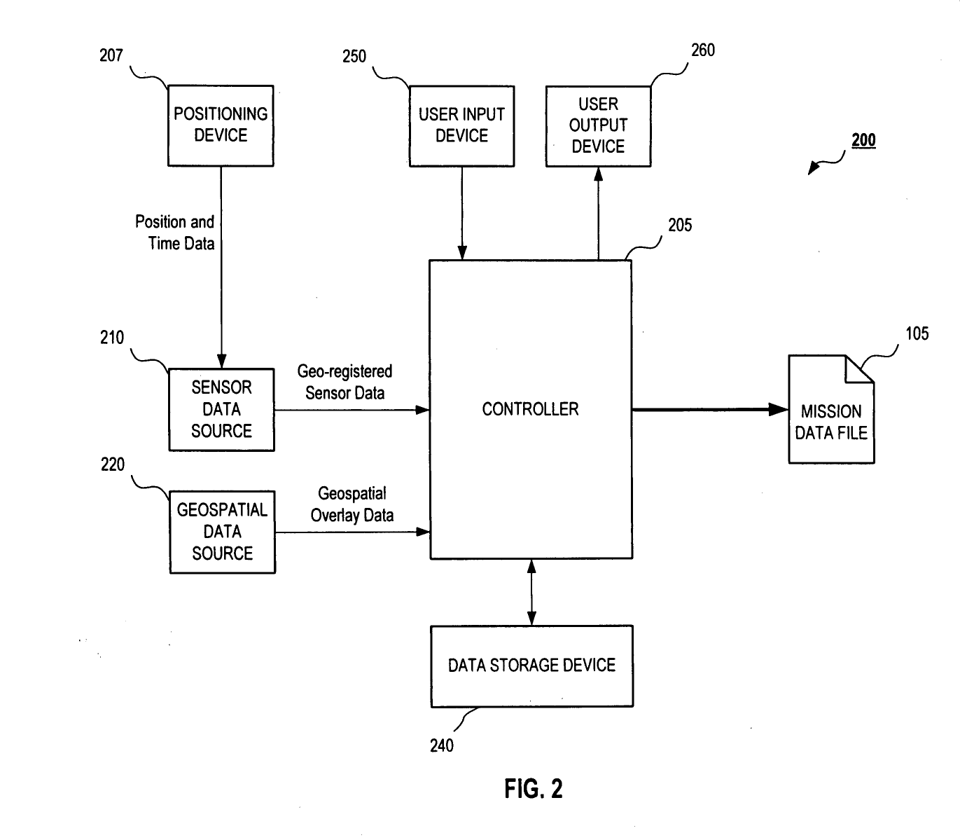

FIG. 2 illustrates an augmented reality unit 200, consistent with the embodiments disclosed herein. As described in more detail below, the exemplary augmented reality unit 200 may be a data processing device that receives geo-registered sensor data and geospatial overlay data for encoding mission data file 105, and for rendering augmented reality presentations. Depending on its configuration, augmented reality unit 200 may include the functionality of the above-described recorder unit 110, editor unit 120, and/or playback unit 130.

As illustrated in FIG. 2, augmented reality unit 200 may include controller 205, positioning device 207, sensor data source 210, geospatial data source 220, data storage device 240, user input device 250, and user output device 260. The controller 205 may be implemented as one or more data processing systems including; for example, a computer, a personal computer, a minicomputer, a microprocessor, a workstation, a laptop computer, a hand-held computer, a personal digital assistant, or similar computer platform typically employed in the art.

Positioning device 207 may be a device for determining the time, location, and orientation of the augmented reality unit 200. Positioning device 207 provides time and position to sensor data source 210 and/or controller 205 for geo-referencing captured audiovisual data and marker data. Positioning device 207 may include one or more navigation systems such as a global positioning system and/or an inertial navigation system, or other such location sensors.

Sensor data source 210 may be any device for capturing and storing geo-registered sensor data. Sensor data source 210 may include devices for recording video, audio, and/or other geo-referenced data. The sensor data source 210 may be provided on any platform including, for example, handheld devices (e.g., camera, personal digital assistant, portable computer, telephone, etc.), or a vehicle (car, truck, aircraft, ships, and spacecraft, etc.). Sensor data source 210 devices include video and audio input devices that receive position and altitude instrumentation form positioning device 207. Video input devices may include an analog or a digital camera, a camcorder, a charged coupled device (CCD) camera, or any other image acquisition device. Audio input devices may be a microphone or other audio transducer that converts sounds into electrical signals. Sensor data sources 210 are not limited to manned systems and also may include other sources, such as remote surveillance video and satellite-based sensors.

Geospatial data source 220 may include any source of geospatial data. For instance, a geospatial data source may be an existing mission data file 105, an external geospatial information system (a.k.a. “GIS”), a mission planning system, an interactive map system, or an existing database that contains location based information.

Data storage device 240 may be associated with augmented reality unit 200 for storing software and data consistent with the disclosed embodiments. Data storage device 240 may be implemented with a variety of components or subsystems including, for example, a magnetic disk drive, an optical disk drive, a flash memory, or other devices capable of storing information. Further, although data storage device 240 is shown as part of augmented reality unit 200, it instead may be located externally. For instance, data storage device 240 may be configured as network accessible storage located remotely from augmented reality unit 200.

User input device 250 may be any device for communicating a user's commands to augmented reality unit 200 including, but not limited to, keyboard, keypad, computer mouse, touch screen, trackball, scroll wheel, joystick, television remote controller, or voice recognition controller.

User output device 260 may include one or more devices for communicating information to a user, including video and audio outputs. Video output may be communicated by any device for displaying visual information such as a cathode ray tube (CRT), liquid crystal display (LCD), light emitting diode display (LED), plasma display, or electroluminescent display. Audio output may be a loudspeaker or any other transducer for generating audible sounds from electrical signals.

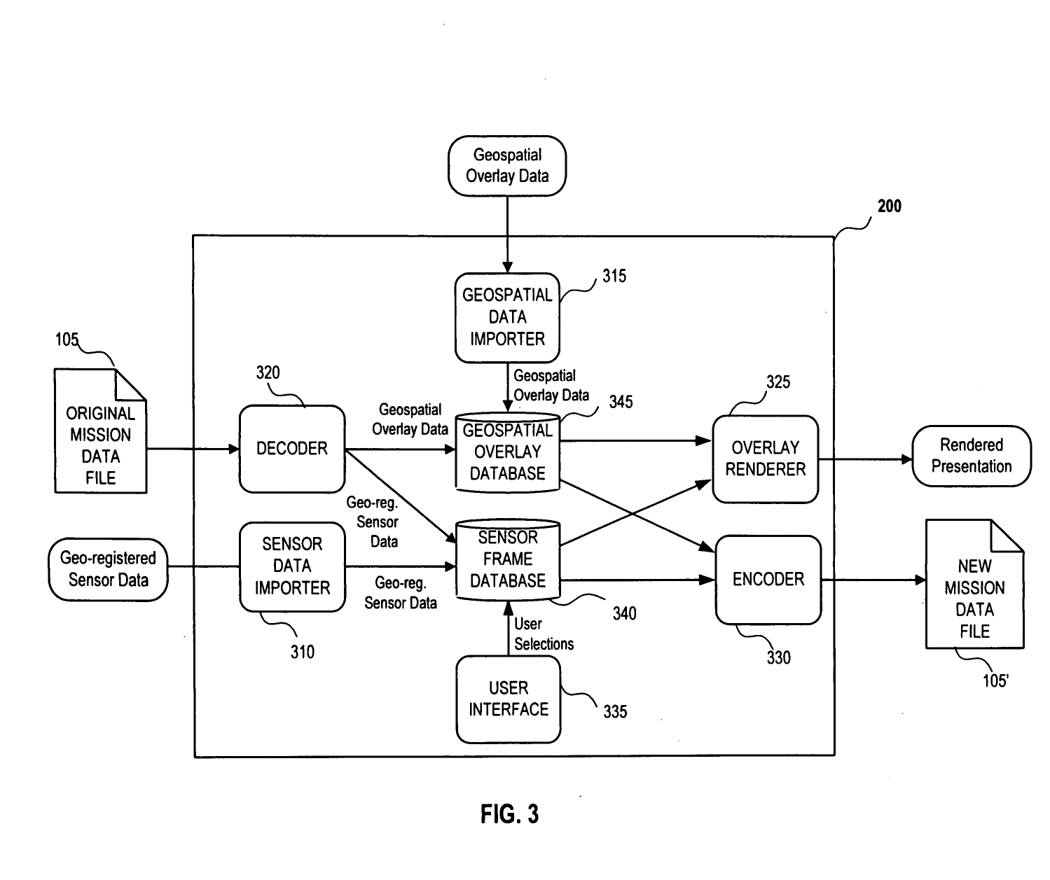

FIG. 3 illustrates a functional block diagram of exemplary augmented reality unit 200. Augmented reality unit 200 may receive geo-registered sensor and geospatial overlay data for rendering augmented reality presentations and encoding mission data files. Augmented reality unit 200 may include sensor data importer 310, mission data file decoder 320, geospatial data importer 315, overlay renderer 325, mission data file encoder 330, user interface 335, sensor frame database 340, and geospatial overlay database 345.

Sensor data importer 310 is a software module containing instructions for receiving geo-registered sensor data from sensor data sources and storing the geo-referenced sensor frames in the sensor frame database 340. For example, sensor data importer 310 may receive frames of audiovisual data and associated metadata from recorder unit 110 including a video camera and global positioning system unit. Based on the metadata, including position, orientation, and/or time data, sensor data importer 310 may store the frames geo-referenced video data received from the camera in image from database 340.

Geospatial data importer 315 is a software module containing computer-readable instructions executable by a processor to populate geospatial overlay database with data received from geospatial data source 220. Geospatial data importer 315 may have a modular architecture allowing the module to import geospatial overlay data from a specific geospatial data source 220.

Decoder 320 is a software module containing computer-readable instructions executable by a processor to receive a mission data file 105, extract geo-registered sensor data and geospatial overlay data, and store the extracted data in the sensor frame database 340 and geospatial overlay database 345, respectively.

Overlay renderer 325 is a software module containing computer-readable instructions executable by a processor to extract data from sensor frame database 340 and geospatial overlay database 345, and combine the data into a single display image for presentation on, for example, the user output device 260 shown in FIG. 2. Overlay renderer 325 may create an augmented reality representation of the selected geospatial overlay data using a “virtual sensor” that is matched to an actual sensor device 210 in, for example, recorder unit 110 used to capture frames of geo-registered sensor data. The sensor frame metadata is used to locate, orient, and model the virtual sensor. The graphically combined output of the virtual sensor and sensor frame creates an augmented reality presentation.

Encoder 330 is a software module containing computer-readable instructions executable by a processor to encode new mission data file 105 from select data in sensor frame database 340 and geospatial overlay database 345. Encoder 330 may, in some cases, combine (i.e., “flatten”) all information into a single compressed file for distribution and archiving.

User interface 335 may include computer-readable instructions and be configured to enable a person using user interface 335 to control augmented reality unit 200. User interface 335 may, for example, be implemented as graphical user interface 335 including conventional screen elements, such as menus, lists, tables, icons, action buttons, and selection or text entry fields, for these purposes. User interface 335 allows a user to add or remove geospatial overlay database and frame database entries. Furthermore, through user interface 335, the user can define scripts for controlling the playback of mission data in a predefined sequence of events and/or add markers for referencing portions of the data during playback.

Sensor frame database 340 may be a database with extensions for storing, querying, and retrieving sensor frames. A sensor frame contains the raw sensor data together with associated geospatial and non-geospatial metadata. Frames may be stored and referenced in the sensor frame database 340 based on source and time. Alternatively, a location based referencing may be applied.

Geospatial overlay database 345 may be a database with extensions for storing, querying, and manipulating geographic information and spatial data. Geospatial overlay data may be stored and referenced in the geospatial overlay database 345 based on associated layer, object type, and position.

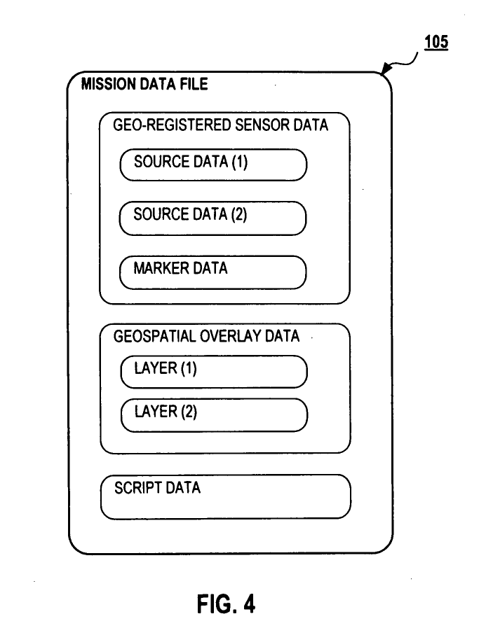

FIG. 4 illustrates an exemplary mission data file 105. A mission data file 105 may include geo-registered sensor data and geospatial overlay data and mission review scripts, in addition to other data. The geo-registered sensor data may be obtained from multiple different sources of sensor data captured simultaneously, sequentially, or at different times. As shown in FIG. 4, geo-registered sensor data may be organized by the source of the data and, further organized by “frame.” The data for each frame may include a video image (e.g., raster images) and/or associated audio. Each frame of sensor data may be associated with metadata describing the data in the frame, including, at least, a timestamp and a position. For instance, metadata for a frame captured by a video camera may include: a time, a geospatial position (e.g., latitude, longitude, altitude), a description of the camera's orientation, and parameters describing the camera's settings.

Furthermore, geo-registered sensor data may include marker data representing events, objects, or conditions designated by a user. Marker data may be audio, text, symbols, icons, hand-drawn annotations. In some cases, marker data may be provided while the geo-registered sensor data is being recorded. In other cases, a user creating a modified mission data file 105 may, for example, provide marker data that is stored in the mission data file with the geo-registered sensor data.

Each frame may also include a list of relevant geospatial overlays and variations from primary geospatial overlay data. In accordance with embodiments of the present invention, the metadata may be used to limit the geospatial overlay data included in the mission data file 105. For instance, based on the metadata, any geospatial overlays outside the field of view of the image capture device may be excluded from the mission data file 105.

Geospatial overlay data provides the computer-generated (i.e., virtual) objects to add as overlay content for each frame of geo-registered sensor data. Geospatial overlays may be organized in the mission data file 105 as hierarchical layers. In addition, a geospatial overlay is associated with metadata describing a unique identifier, position, and label for each object. Each object also may have a description, such as, for example, a label and an address of a house.

As described above, mission data file 105 may also include mission review scripts to automate the playback of a mission data in order to create predefined “walkthough” of a mission or part of a mission. In other words, a script may capture a sequence of events for automatic playback of geo-registered sensor data and geospatial overlay data in an augmented reality presentation decoded from mission data file 105.

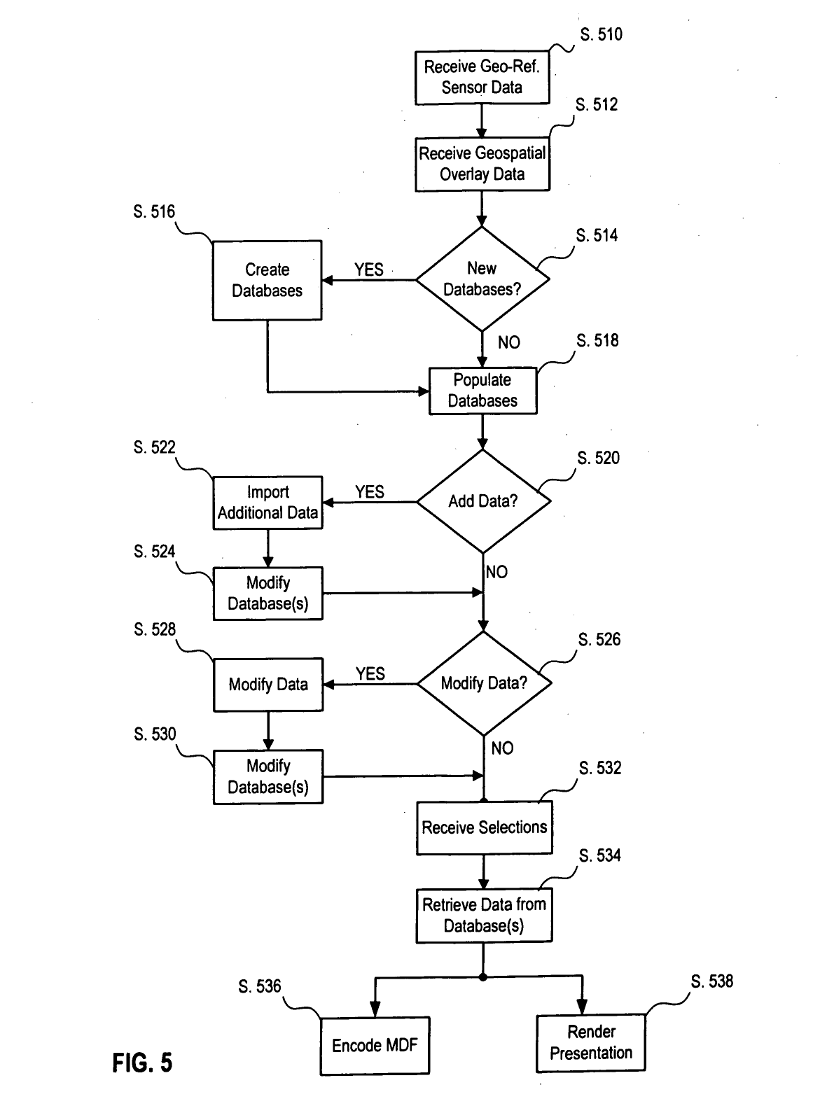

FIG. 5 shows a flowchart illustrating an exemplary method, consistent with the embodiments disclosed herein. Augmented reality unit 200 may receive geo-referenced sensor data from, for example, recorder unit 110 (S. 510). Augmented reality unit 200 may alternatively or additionally receive geospatial overlay data (S. 512). In some cases, augmented reality unit 200 may receive the geo-referenced sensor data and geospatial overlay data by extracting the data from an existing mission data file 105. However, in other cases, the geo-referenced sensor data and geospatial overlay data may be received from any known provider of this data, such as a commercial vendor of satellite imagery, commonly used in the art.

Next, augmented reality unit 200 may determine whether to create new sensor frame database 340 and/or geospatial overlay database 345 or update existing ones. This determination may be made base on a selection received from a user through user interface 335 using, for instance, a typical graphic user interface. If it is determined that new databases 340 and 345 are not to be created (S. 514, NO), augmented reality unit 200 imports the new geo-referenced sensor data and geospatial overlay data using a corresponding one of sensor data importer 310 or geospatial data importer 315. The augmented reality unit 200 then populates the existing sensor frame database 340 and geospatial overlay database 345 with the extracted geo-registered sensor data and geospatial overlay data (S. 518). In the case where the data is included in a mission data file 105, augmented reality unit 200 may decode the mission data file 105 using decoder 320 and extract the geo-registered sensor data and geospatial overlay data.

If the augmented reality unit 200 determines that new sensor frame database 340 and/or geospatial overlay database 345 are to be created (S. 514, YES), augmented reality unit 200 generates new databases 340 & 345 for storing corresponding geo-registered sensor data and geospatial overlay data (S. 516). The imported geo-registered sensor data and geospatial overlay data is used to populate the new sensor frame database 340 and geospatial overlay database 345 (S. 518). In the case where the geo-registered sensor data and geospatial overlay data is included in an existing mission data file 105, augmented reality unit 200 may decode the mission data file 105 using decoder 320 to extract the geo-registered sensor data and geospatial overlay data, and then store the data in a corresponding one of sensor frame database 340 and geospatial overlay database 345.

Once sensor frame database 340 and geospatial overlay database 345 are populated, a user, through user interface 335 and input device 250, may choose to add new data to these databases (S. 520). In this circumstance (S. 522, YES), augmented reality unit 200 may import new geo-registered sensor from geospatial data source 220 using sensor data importer 310, for example. Likewise, augmented reality unit 200 may import new geospatial overlay data from a geospatial data source 220 using geospatial data importer 220 (S. 522). After the new data is imported, databases 340 and 345 may be modified to add the new geo-registered sensor data and geospatial overlay data (S. 524). Otherwise, (S. 522, NO), the process may carry on without importing additional data.

In addition, a user, via user interface 335 and input device 250, may choose whether or not to modify the data in databases 340 and 345 (S. 526). If so (S. 526, YES), the user may modify the databases 340 and 345 by editing, deleting, or replacing data (S. 528). In some instance, a user may replace an entire database 340 and 345 as a whole, such as when an updated geospatial overlay becomes available and making the current geospatial overlay database 345 obsolete. In addition, a user may select layers for presentation during playback and/or create playback scripts. In not (S. 526, NO), the process may proceed without modifying the data in databases 340 and 345.

Simultaneously or subsequently, augmented reality unit 200 may receive selections designating portions of the geo-registered sensor data and/or the geospatial overlay data (S. 532). The selections may be made by a user, for example, via user interface 335. Selections may include one or more sources of geo-referenced sensor data stored in sensor frame database 340. Selections may also include geo-referenced sensor data occurring between points in time or between event markers. Selections may also include geospatial overlay data stored in overlay database 345. For instance, via user interface 335, a user may select between one or more libraries of computer-generated objects.

Based on the selections of geo-registered sensor data and/or geospatial overlay data, augmented reality unit 200 may generate an new mission data file 105′ by extracting data from the sensor frame database 340 and geospatial overlay database 345 including the modifications and selections made by the user (S. 536). The new mission data file 105′ subsequently may be provided to a user of a second augmented reality system 200 for playback and modification, as described above.

Alternatively or additionally, by retrieving the geo-reference sensor data and geospatial overlay stored in the sensor frame database 340 and geospatial overlay database 345, augmented reality unit 200 may render a augmented reality presentation for playback using, for example, user output device 250 (S. 538).

Computer programs based on the written description and exemplary flow charts described herein are within the skill of an experienced developer and/or programmer. The various programs or program content can be created using any of the techniques known to one skilled in the art or can be designed in connection with existing software. Such programs or program content can be designed in or by means of Java, C++, C#, VB.net, Python, Perl, XML, SQL and others programming environments.

Moreover, while illustrative embodiments of the invention have been described herein, further embodiments may include equivalent elements, modifications, omissions, combinations (e.g., of aspects across various embodiments), adaptations, and/or alterations as would be appreciated by those skilled in the art based on the present disclosure.

As disclosed herein, embodiments and features of the invention may be implemented through computer hardware and/or software. Such embodiments may be implemented in various environments, such as networked and computing-based environments with one or more users. The present invention, however, is not limited to such examples, and embodiments of the invention may be implemented with other platforms and in other environments.

The storage mediums and databases referred to herein symbolize elements that temporarily or permanently store data and instructions. Although storage functions may be provided as part of a computer, memory functions can also be implemented in a network, processors (e.g., cache, register), or elsewhere. While examples of databases have been provided herein, various types of storage mediums can be used to implement features of the invention, such as a read only memory (ROM), a random access memory (RAM), or a memory with other access options. Further, memory functions may be physically implemented by computer-readable media, such as, for example: (a) magnetic media, such as a hard disk, a floppy disk, a magnetic disk, a tape, or a cassette tape; (b) optical media, such as an optical disk (e.g., a CD-ROM), or a digital versatile disk (DVD); or (c) semiconductor media, such as DRAM, SRAM, EPROM, EEPROM, memory stick, and/or by any other media, like paper.

Embodiments consistent with the invention also may be embodied in computer program products that are stored in a computer-readable medium or transmitted using a carrier, such as an electronic carrier signal, communicated across a network between computers or other devices. In addition to transmitting carrier signals, network environments may be provided to link or connect components in the disclosed systems. The network can be a wired or a wireless network. To name a few network implementations, the network may be, for example, a local area network (LAN), a wide area network (WAN), a public switched telephone network (PSTN), an Integrated Services Digital Network (ISDN), an infrared (IR) link, a radio link, such as a Universal Mobile Telecommunications System (UMTS), Global System for Mobile Communication (GSM), Code Division Multiple Access (CDMA), or a satellite link.

Other embodiments of the invention will be apparent to those skilled in the art from consideration of the specification and practice of the embodiments of the invention disclosed herein. Further, the steps of the disclosed methods may be modified in any manner, including by reordering steps and/or inserting or deleting steps, without departing from the principles of the invention. It is therefore intended that the specification and examples be considered as exemplary only.

What is claimed is:

1. A method for providing customized augmented reality data comprising:
receiving geo-registered sensor data including data captured by a sensor and metadata describing a position of the sensor at the time the data was captured;
receiving geospatial overlay data including computer-generated objects having a predefined geospatial position;
receiving a selection designating at least one portion of the geo-registered sensor data, said at least one portion of the geo-registered sensor data including some or all of the geo-registered sensor data;
receiving a selection designating at least one portion of the geospatial overlay data, said at least one portion of the geospatial overlay data including some or all of the geospatial overlay data; and
providing a combination of the at least one selected portion of the geo-registered sensor data and the at least one selected portion of geospatial overlay data, said combination being operable to display the at least one selected portion of the geo-registered sensor data overlaid with the at least one selected portion of geospatial overlay data based on the position of the sensor without receiving other geo-registered sensor data or other geospatial overlay data.

2. The method of claim 1, wherein receiving geo-registered sensor data includes:
storing the geo-registered sensor data in a frame database that references frames of geo-registered sensor data based on at least one of a position at which the frame was recorded, a time the frame was recorded, and a source of the frame.

3. The method of claim 1, wherein receiving geospatial overlay data includes:
storing the geospatial overlay data in an overlay database that references computer-generated objects based on at least a geospatial position of each object.

4. The method of claim 1, wherein receiving geo-registered sensor data includes receiving geo-registered sensor data added or modified by a user, and receiving geospatial overlay data includes geospatial overlay data added or modified by a user.

5. The method of claim 1, wherein the geo-registered sensor data includes at least one of: video data, audio data, photographic data, and still-image data.

6. The method of claim 1, wherein the geo-registered sensor data includes marker data representing events, objects, or conditions designated by a user while the geo-registered sensor data is being recorded.

7. The method of claim 1, wherein position metadata includes data describing at least one of position, time, orientation, and field of view.

8. The method of claim 1, wherein providing a combination includes:
encoding the at least one selected geo-registered sensor data and the at least one selected geospatial overlay data in a portable document format.

9. The method of claim 1, wherein the method further includes:
rendering an audiovisual presentation on a display device using the at least one selected portion of the geo-registered sensor data and the at least one selected portion of the geospatial overlay data.

10. A system for providing customized augmented reality data comprising:
a computer having processor and a computer-readable medium coupled to the processor; and
a program stored in the computer-readable medium, the program, when executed by the processor, operable to:
receive geo-registered sensor data including data captured by a sensor and metadata describing a position of the sensor at the time the data was captured;
receive geospatial overlay data including computer-generated objects having a predefined geospatial position;
receive a selection designating at least one portion of the geo-registered sensor data, said at least one portion of the geo-registered sensor data including some or all of the geo-registered sensor data;
receive a selection designating at least one portion of the geospatial overlay data, said at least one portion of the geospatial overlay data including some or all of the geospatial overlay data; and
provide a combination of the at least one selected portion of the geo-registered sensor data and the at least one selected portion of geospatial overlay data, said combination being operable to display the at least one selected portion of the geo-registered sensor data overlaid with the at least one selected portion of geospatial overlay data based on the position of the sensor without receiving other geo-registered sensor data or other geospatial overlay data.

11. The system of claim 10, wherein the received geo-registered sensor data includes frames of audiovisual data, said frames being stored in a frame database that references frames of geo-registered sensor data based on at least one of a position at which the frame was recorded, a time the frame was recorded, and a source of the frame.

12. The system of claim 10, wherein the received geospatial overlay is stored in an overlay database that references computer-generated objects based on at least a geospatial position of each object.

13. The system of claim 10, wherein the received geo-registered sensor data includes geo-registered sensor data added or modified by a user, and the received geospatial overlay data includes geospatial overlay data added or modified by a user.

14. The system of claim 10, wherein the geo-registered sensor data includes at least one of: video data, audio data, photographic data, and still-image data.

15. The system of claim 10, wherein the geo-registered sensor data includes marker data representing events, objects, or conditions designated by a user while the geo-registered sensor data is being recorded.

16. The system of claim 10, wherein position metadata includes data describing at least one of position, time, orientation, and field of view.

17. The system of claim 10, wherein the program is operable to combine the at least one selected portion of the geo-registered sensor data and the at least one selected portion of the geospatial overlay data by encoding the at least one selected portion of the geo-registered sensor data and the at least one selected geospatial portion of the overlay data in a portable document format.

18. The system of claim 10, wherein the program is further operable to:
render an audiovisual presentation on a display device using the at least one selected geo-registered sensor data and the at least one selected geospatial overlay data.

19. A method for providing customized augmented reality data, comprising:
receiving geo-registered sensor data including data captured by a sensor and metadata describing a position of the sensor at the time the data was captured;
storing the geo-registered sensor data in a frame database that references frames of geo-registered sensor data based on at least one of a position at which the frame was recorded, a time the frame was recorded, and a source of the frame;
receiving geospatial overlay data including computer-generated objects having a predefined geospatial position;
storing the geospatial overlay data in an overlay database that references computer-generated objects based on at least one of a geospatial position of each object;
receiving a selection designating at least one portion of the geo-registered sensor data in the sensor frame database, said at least one portion of the geo-registered sensor data including some or all of the sensor frame database;
receiving a selection designating at least one portion of the geospatial overlay data in the overlay database, said at least one portion of the geospatial overlay data including some or all of the geospatial overlay data in the overlay database; and
encoding a mission data file including the at least one selected geo-registered sensor data and the at least one selected geospatial overlay data, said mission data file being operable to display the selected portions of the geo-registered sensor data overlaid with the geospatial overlay data based on the position of the sensor without receiving other geo-registered sensor data or other geospatial overlay data.

20. The method of claim 19, wherein the received geo-registered sensor data and the received selected geospatial overlay data are decoded from a first mission data file.
